(19) United States
(12) Patent Application Publication
(10) Pub. No.: US 2016/0007635 A1
(43) Pub. Date: Jan. 14, 2016

(54) POWDER COMPOSITION

(71) Applicant: Laped Di Pastorello Claudio E Fabio S.N.C., Ospedaletto Euganeo (IT)

(72) Inventor: Salvatore Cannavo, Ospedaletto Euganeo (IT)

(21) Appl. No.: 14/328,208

(22) Filed: Jul. 10, 2014

(51) Int. Cl. A23L 1/09

(52) U.S. Cl. CPC A23L 1/097; A23V 2002/00

(57) ABSTRACT

Powdered composition for pastries adapted to obtain a creamy substitute product of pastry cream; the composition comprises: 22% to 39% by weight, relative to the overall weight of the composition, of erythritol; 28% to 45% by weight, relative to the overall weight of the composition, of at least one bulk sweetener; 16% to 30% by weight, relative to the overall weight of the composition, of starch; and (from 0.3%) up to 1.5% by weight, relative to the overall weight of the composition, of carrageenin.

### TECHNICAL FIELD

The present invention concerns a powder composition.

### BACKGROUND TO THE INVENTION

Normally pastry cream is prepared using the following ingredients: sucrose, egg yolks, liquid full-cream milk, wheat flour and/or starches (rice starch, maize starch) and/or potato starches.

In some cases, the sucrose has been partially substituted by dextrose, glucose syrup and/or fructose.

The preparation of traditional pastry cream is relatively lengthy and usually requires the use of costly machinery (pastry cream pasteurizers, normally called cream cookers). The pasteurization time is approximately two hours and the mean capacity of this machinery is around 50-60 kg of cream produced.

Furthermore, if fresh eggs are used, the production workshop must have an isolated area dedicated to shelling and preparation of the eggs. The pasteurization cycle is automatic with heating up to 85-90° C. and cooling up to approximately 8-10° C. At the end of the cycle, the pasteurizer keeps the pastry cream inside it at the conservation temperature. To perform a further pasteurization cycle, the pasteurizer must be emptied and the pastry cream kept at controlled temperatures, occupying space which is almost always insufficient in pastry workshops.

Consequently, an increasing number of producers prefer to adopt alternative solutions. One of these solutions consists in the use of powder compositions, not containing eggs, which are diluted with liquids (water or milk) normally in a ratio of 1 powder : 2.5 liquid.

In view of the fact that the diet of industrialized countries is increasingly high-calorie, the need is felt for food with a reduced calorie content, reducing the fat and/or sugar content thereof.

In many products these modifications are not simple and, often, when the product type does not allow modification of the dry substance content, the messages conveyed to the consumer are misleading, highlighting the reduced content of a nutrient but omitting to mention the fact that when one nutrient is reduced, one or more of the others must necessarily be increased and, consequently, the caloric content can remain the same or is even increased.

In this context, pastry cream preparations with a low caloric content, and flavor, consistency and usability analogous to that of the traditional pastry cream have not yet been proposed.

The object of the present invention is to provide a powder composition which overcomes, at least partially, the drawbacks of the known art and is, at the same time, easy and inexpensive to produce and/or use.

### SUMMARY

According to the present invention a powder composition is provided as claimed in the following independent claims and, preferably, in any one of the claims depending directly or indirectly on the independent claims.

### DETAILED DISCLOSURE

According to one aspect of the present invention, a powder composition (for pastries) is provided.

In particular, the composition is adapted to obtain (by means of mixing with water and/or milk) a (creamy) substitute product of pastry cream. More precisely, the composition can be used (mixing it with water or milk) for the production of a cream similar to pastry cream, from which it differs due to the absence of some components such as sucrose and egg yolks.

The composition comprises erythritol and at least one bulk sweetener. According to some embodiments, the composition comprises from 22% (in particular, from 24%) to 39% (in particular, to 32%) by weight, relative to the overall weight of the composition, of erythritol. Advantageously, the composition furthermore comprises from 28% (in particular, from 30%) to 45% (in particular, to 38%) by weight, relative to the overall weight of the composition, of the bulk sweetener. Usually, the composition comprises the bulk sweetener in a greater quantity than the erythritol.

In particular, the bulk sweetener has a caloric value lower than 3.2 Kcal/g and a sweetening power higher than 40% of the sweetening power of sucrose.

It is important to underline that although the sweetening power is subjectively variable, for each known sweetener the sweetening power is well defined and widely documented values exist. In the absence of documented values it is nevertheless possible to evaluate the sweetening power by means of panel tests for comparison with sweeteners with known sweetening power (for example sucrose).

According to some embodiments, the bulk sweetener is (comprises a sweetener) selected in the group consisting of: sorbitol, mannitol, isomalt, maltitol, lactitol, xylitol and a combination thereof. More specifically, the bulk sweetener is selected in the group consisting of: isomalt, maltitol and a combination thereof. Advantageously, the bulk sweetener comprises (more precisely, is) isomalt.

Erythritol has a practically null caloric value and glycemic and insulin indexes, a sweetening power of approximately 70% with respect to sucrose, an organoleptic profile similar to sucrose, a high digestive tolerance and antiradical, anticarcinogenic and antiplaque activity.

Despite this, when eaten it produces a sensation of freshness on the palate.

In the present case, the bulk sweetener synergically combines with the erythritol so as to obtain a creamy product with reduced caloric content and a flavor (in particular a sweetness) surprisingly similar to that of traditional pastry cream.

It should be noted that isomalt and erythritol help to prevent tooth decay and slow down the formation of plaque. Their low glycemic index reduces the sudden increase in glucose in the blood.

According to some embodiments, the composition comprises 1% to 6% (in particular, 2% to 4%) by weight, relative to the overall weight of the composition, of fructose. Fructose further “rounds” the taste (it has a high sweetening power and a low glycemic impact).

According to some embodiments, the composition comprises at least one thickener. Advantageously, the composition comprises from 16% (in particular, from 19%) to 31% (in particular, to 24%) by weight, relative to the overall weight of the composition, of the thickener. In particular, the thickener is (comprises a thickener) selected in the group consisting of: starch, carrageenin, pectin, agar agar, sodium alginate and a combination thereof.

According to some embodiments, the thickener comprises (in some cases, is) starch (also in the form of potato starch). Advantageously, the composition comprises from 16% (in particular, from 19%) to 30% (in particular, to 23%) by weight, relative to the overall weight of the composition, of starch.

In particular, the starch is selected in the group consisting of: starch derived from potato, starch derived from rice, starch derived from maize and a combination thereof. In some cases, the starch comprises (more precisely, is) starch derived from potato. According to some embodiments, the starch comprises (more precisely, is) modified starch (in particular, derived from potato). More specifically, the starch comprises (more precisely, is) a pregelatinized acetylated di-starch phosphate (derived from potato). An example of starch is ELIANE BC 160 (by Brenntag S.p.A.—Milan, Italy).

The presence of modified starch allows production of the creamy product by mixing the composition and a liquid (milk or water) at substantially ambient temperature without the need to provide heat.

Advantageously, the thickener comprises a thickening component selected in the group consisting of: carrageenin, pectin, agar agar, sodium alginate and a combination thereof. According to some embodiments, the thickener comprises (in particular, is) carrageenin.

Once the composition is mixed with the liquid (water or milk) the carrageenin performs its thickening function with surprising effectiveness. It has been hypothesised that this is due to the fact that the carrageenin reacts with the calcium of the milk or of the powdered milk or the calcium deriving from other sources (e.g. from calcium chloride).

Advantageously, the composition comprises up to 1.5% (in particular, up to 0.8%; more precisely, up to 0.7%) by weight, relative to the overall weight of the composition, of said thickening component. In particular, the composition comprises at least 0.3% (in particular, at least 0.4%; more precisely, at least 0.5%) by weight, relative to the overall weight of the composition, of said thickening component.

Advantageously, the composition comprises xanthan gum. According to some embodiments, the composition comprises from 0.1% (in particular, from 0.2%) to 1% (in particular, to 0.3%) by weight, relative to the overall weight of the composition, of xanthan gum. An example of xanthan gum is KUW Xanthan Gum 200 (by IMCD Deutschland GmbH & Co. KG—Köln).

It has been experimentally observed that xanthan gum acts synergically together with the carrageenin, opposing the syneresis of the creamy product also in the long term.

Advantageously, the composition comprises at least one calcium salt (in particular, calcium chloride). According to some embodiments, the composition comprises from 0.01% (in particular, from 0.02%) to 0.7% (in particular, to 0.25%) by weight, relative to the overall weight of the composition, of the calcium salt (in particular, calcium chloride).

It has been experimentally observed that the action of the carrageenin is improved in the presence of the calcium salt (calcium chloride). It has been hypothesised that this improvement is due to the fact that the carrageenin has a greater available concentration of calcium.

Advantageously, the composition comprises plant fiber. According to some embodiments, the fiber is (comprises a fiber) selected in the group consisting of: oat fiber, bamboo fiber, pea fiber and a combination thereof. According to some embodiments, the composition comprises from 1% (in particular, from 1.5%) to 5.5% (in particular, to 3.5%) by weight, relative to the overall weight of the composition, of the plant fiber.

Advantageously, the composition comprises inulin. According to some embodiments, the composition comprises from 1% (in particular, from 1.5%) to 5.5% (in particular, to 3.5%) by weight, relative to the overall weight of the composition, of inulin.

Inulin and fiber (in particular, oat fiber) contribute to the density and stabilisation of the creamy product. In particular, oat fiber performs emulsifying functions and is an excellent substitute for fats. It is also an excellent source of beta-glucans, which help to reduce cholesterol.

Advantageously, the composition comprises at least one flavoring substance. According to some embodiments, the composition comprises from 0.01% (in particular, from 0.02%) to 1% (in particular, to 0.2%) by weight, relative to the overall weight of the composition, of the flavoring substance. According to some embodiments, the flavoring substance is selected in the group consisting of: pastry cream flavoring substance, vanilla flavoring substance, lemon (lemon rind) flavoring substance and a combination thereof. In some cases, the flavoring substance comprises (more precisely, is) pastry cream flavoring substance.

Advantageously, the composition comprises powdered milk. According to some embodiments, the composition comprises from 4% (in particular, from 9%) to 22% (in particular, to 21%) by weight, relative to the overall weight of the composition, of powdered milk. According to some variations, the powdered milk contains (more precisely, is) low-fat and/or full-fat powdered milk.

In some cases, the composition comprises from 5% to 15% by weight, relative to the overall weight of the composition, of low-fat powdered milk. In addition or alternatively, the composition comprises from 4% to 14% by weight, relative to the overall weight of the composition, of full-fat powdered milk.

The use of a mixture of low-fat and full-fat powdered milk gives the product the milky note typical of pastry cream. In this way, the composition can be mixed simply with water to reduce the caloric content.

Advantageously, the composition comprises salt (sodium chloride). According to some embodiments, the composition comprises from 0.1% (in particular, from 0.02%) to 0.7% (in particular, to 0.4%) by weight, relative to the overall weight of the composition, of salt (sodium chloride, which acts as a flavour enhancer).

Advantageously, the composition comprises beta-carotene in a concentration up to 0.3% (in particular, at least 0.2%) by weight, relative to the overall weight of the composition. Beta-carotene, due to its yellow-orange coloring, gives the composition (more precisely the substitute product of the pastry cream obtainable from it) the typical color of the classic pastry cream.

According to some embodiments, the composition does not comprise further ingredients apart from those indicated (each time).

Advantageously, the powder consists of particles with size (i.e. diameter) up to 100 μm (in particular, 90 μm). In particular, the powder consists of particles with size (i.e. diameter) from 70 μm (in particular, from 80 μm).

The size is obtained by means of successive screening with sieves having holes of decreasing size (diameters). The diameter of the holes of the first sieve which does not allow the passage of the particles indicates the size (i.e. diameter) of the particles.

The measurements by means of successive screening are performed as long as the sizes (i.e. diameters) of the particles and of the sieve holes allow it (in particular, up to a minimum of 0.05 mm). Below these sizes (in particular, 0.05 mm), the sizes of the particles are measured as mean diameter D(v,0.5) measured by means of a laser granulometer—in particular, using a Mastersizer Microplus Ver.2.19 laser granulometer (Malvern Instruments® Ltd).

The fact that the particles have a granulometry without great dimensional differences makes it less likely that the ingredients with larger particles will deposit on the bottom, making the composition non-homogeneous.

In this regard, it should be noted that, according to advantageous embodiments, the composition is a preparation (i.e. a mixture) of the ingredients (for example, erythritol, bulk sweetener and thickener) indicated above (in the percentages given above).

In this way, the complexity of the user's work is further reduced. He/she simply has to mix the composition (preparation) with a suitable liquid (for example, water or milk) without having to combine several components.

According to alternative embodiments, the composition is not a mixture and one or more of the ingredients described above is at least partially separated from the others (for example, in different sachets). In these cases, the composition is a kit comprising the ingredients described above (and if necessary tools—for example, spoons and/or measurers—for processing the composition).

Note that, in any case, it has been experimentally observed that preparations having particles with granulometry larger than those indicated above result in a product significantly and surprisingly worse (in particular in terms of consistency) than the product obtained with preparations having particles of the size indicated.

The composition of the present invention has experimentally shown important and surprising advantages with respect to the state of the art. In particular, the composition is extremely similar (in terms of both the organoleptic and rheological characteristics) to the traditional pastry cream and at the same time has extremely low caloric value and glycemic and insulin indexes.

Further characteristics of the present invention will become clear from the following description of merely illustrative and non-limiting examples.

### EXAMPLE 1

A composition was produced having the composition shown in table 1.

TABLE 1

| | | Quantity (% |
|---|---|---|
| | | by weight |
| | | out of |
| | Producer (PR) | overall weight |
| Ingredient | Distributor (DS) | of composition) |
| Isomalt | Cargill (PR and DS) | 34 |
| (C*IsoMaltidex 16502) | | |
| Erythritol | Cargill (PR and DS) | 28 |
| (Zerose ™ 16959) | | |
| Pregelatinized starch | Brenntag (PR and DS) | 21 |
| (ELIANE BC 160) | | |
| Low-fat powdered milk | Mamolik (PR) | 6 |
| | Migliora (DS) | |
| Full-fat powdered milk | Mamolik (PR) | 5 |
| | Migliora (DS) | |
| Inulin | Senus (PR) | 2 |
| (Fruttafit HD) | Chimab (DS) | |
| Oat fiber | Tate & Lyle (PR) | 2.5 |
| (Promoat betaglucan) | Abs Food (DS) | |
| Carrageenin | GTC (PR and DS) | 0.6 |
| (Getralacta 2135) | | |
| Salt | Panizza (DS) | 0.3 |
| (sodium chloride) | | |
| Beta-carotene | CHR Hansen (PR) | 0.2 |
| (BC-100Y-WSP) | Biochim (DS) | |
| Xanthan gum | Biotechnologies (PR)- | 0.2 |
| (KUW Xanthan Gum 200) | IMCD (DS) | |
| Calcium chloride | Acef (DS) | 0.1 |
| Flavouring substance (pastry | DKS Aromatic (PR) | 0.06 |
| cream flavouring substance | P. Gianni (DS) | |
| 251018/1) | | |
| Flavouring substance | Kerry (PR e DS) | 0.04 |
| (Drycell pastry cream | | |
| flavouring substance | | |
| 103543) | | |

| | |
|---|---|
| Total | 100 |

The erythritol and isomalt were ground separately so as to obtain particles with dimensions of 80-90μm, having ensured that these sweeteners do not amalgamate. The calcium chloride was ground in the presence of dry air (to avoid it becoming wet, since it is very hygroscopic).

Single doses of flavoring substance, salt, calcium chloride, xanthan gum, carrageenin and beta-carotene were prepared, mixing them thoroughly to obtain a homogeneous compound.

After preparing the doses of the other components, all the ingredients were placed in a mixer of appropriate capacity, beginning with the heaviest one. The ingredients were placed in the mixer in the following sequence: isomalt, erythritol, modified starch, low-fat and full-fat powdered milk, the single dose previously prepared, the inulin and, lastly, the oat fiber.

The mixer was started, operating it for approximately 10 minutes. It was then stopped, part of the product was taken out (approximately one tenth of the mass) so as to recover any parts that were not well mixed, and it was then replaced in the mixer. It was agitated for a further ten minutes and the previous operation was repeated. The mixer was re-started for the third time for a further 10 minutes. The degree of mixing was checked and the chemical-physical characteristics of the composition were tested in the laboratory.

### EXAMPLE 2

400 grams of the composition produced according to example 1 were mixed with 1 liter of water so as to obtain a creamy product which was compared with a creamy product obtained from a state-of-the-art powdered mixture and with a traditional pastry cream.

The study involved a board of 5 judges aged between 30 and 50, purposely trained in sensorial analysis.

Each judge evaluated samples of the three products cited above without knowing what they were (the samples were presented in glasses identified by codes). Each judge was instructed on how to perform the tasting as follows: rinse your mouth with natural mineral water before the evaluation, taste the samples in the order presented, from left to right, and answer the test questions. To reduce the psychological and physiological errors made by the judges during the evaluation and due to the order of presentation of the samples, the tasting sequence was random. Each judge was asked to identify the best sample in relation to the following aspects: resistance to cooking, colour, sweetness, absence of aftertaste.

The results are reported below in table 2, in which A indicates a creamy product obtained from a state-of-the-art powdered mixture, B indicates a creamy product obtained from the composition of example 1, and C indicates the traditional pastry cream.

TABLE 2

| | Resistance to | | | Absence of |
|---|---|---|---|---|
| Judge | Cooking | Colour | Sweetness | Aftertaste |
| 1 | A = B = C | A = B = C | A | A = B = C |
| 2 | A = B = C | A = B = C | C | A = B = C |
| 3 | A = B = C | B | B | A = B = C |
| 4 | A = B = C | B | B | A = B = C |
| 5 | A = B = C | B | B | A = B = C |

From the results recorded, it can be seen that the product obtained from the composition according to the present invention has surprisingly similar characteristics to those of the traditional pastry cream.

1. A powder composition; the composition being adapted to obtain a substitute product of pastry cream and comprising: 22% to 39% by weight, relative to the overall weight of the composition, of erythritol; 28% to 45% by weight, relative to the overall weight of the composition, of at least one bulk sweetener; and 16% to 31% by weight, relative to the overall weight of the composition, of at least one thickener.

2. A composition according to claim 1, wherein the bulk sweetener is selected in the group consisting of: sorbitol, mannitol, isomalt, maltitol, lactitol, xylitol, and a combination thereof; the thickener being selected in the group consisting of: starch, carrageenin, pectin, agar agar, sodium alginate, and a combination thereof.

3. A composition according to claim 1, wherein the thickener comprises 16% to 30% by weight, relative to the overall weight of the composition, of starch and (from 0.3%) up to 1.5% by weight, relative to the overall weight of the composition, of a further component selected in the group consisting of: carrageenin, pectin, agar agar, sodium alginate, and a combination thereof.

4. A composition according to claim 3, wherein the starch comprises a modified starch, in particular a potato-derived pregelatinized acetylated di-starch phosphate.

5. A composition according to claim 1, and comprising 0.1% to 1% by weight, relative to the overall weight of the composition, of xanthan gum.

6. A composition according to claim 1, and comprising up to 0.7% by weight, relative to the overall weight of the composition, of calcium chloride.

7. A composition according to claim 1, and comprising 1% to 5.5% by weight, relative to the overall weight of the composition, of plant fiber, in particular a fiber selected in the group consisting of: oat fiber, bamboo fiber, pea fiber, and a combination thereof.

8. A composition according to claim 1 and comprising 1% to 5.5% by weight, relative to the overall weight of the composition, of inulin.

9. A composition according to claim 1 and comprising 0.01% to 1% by weight, relative to the overall weight of the composition, of a flavouring substance selected in the group consisting of: pastry cream flavouring substance, vanilla flavouring substance, lemon flavouring substance, and a combination thereof.

10. A composition according to claim 1 and comprising 4% to 22% by weight, relative to the overall weight of the composition, of powdered milk.

11. A composition according to claim 1 and comprising 0.1% to 0.7% by weight, relative to the overall weight of the composition, of salt.

12. A composition according to claim 1, wherein the powder consists of particles with sizes ranging from 80 μm to 90 μm.

13. A composition according to claim 1, wherein the composition is a preparation (i.e. a mixture) (of said components).
